(19) United States
(12) Patent Application Publication
(10) Pub. No.: US 2026/0089042 A1
(43) Pub. Date: Mar. 26, 2026

(54) MASK-COMPLIANT RADIO FREQUENCY POWER ENHANCEMENT

(71) Applicant: QUALCOMM Incorporated, San Diego, CA (US)

(72) Inventors: Steve Andre BEAUDIN, Fremont, CA (US); Yuxin WANG, San Jose, CA (US); Puming FANG, Milpitas, CA (US)

(21) Appl. No.: 18/895,853

(22) Filed: Sep. 25, 2024

(51) Int. Cl. H04L 27/26

(52) U.S. Cl. CPC H04L 27/2623; H04L 27/2627

(57) ABSTRACT

Various aspects of the present disclosure generally relate to wireless communication. In some aspects, a user equipment (UE) may perform a crest factor reduction on a radio frequency (RF) waveform in multiple passes, wherein the multiple passes each include: a clipping operation to reduce a peak-to-average power ratio (PAPR) associated with the RF waveform according to a threshold; and a filtering operation to remove at least a portion of out-of-band emission from the clipped RF waveform. The UE may transmit the RF waveform over a wireless channel, wherein the RF waveform transmitted over the wireless channel satisfies a spectral mask. Numerous other aspects are described.

### FIELD OF THE DISCLOSURE

Aspects of the present disclosure generally relate to wireless communication and specifically relate to techniques, apparatuses, and methods associated with a mask-compliant radio frequency power enhancement.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. In other examples, a wireless local area network (WLAN) conforming to the Institute of Electrical and Electronics Engineers (IEEE) 802.11 family of standards (also known as Wi-Fi) may be formed by one or more wireless access points (APs) that provide a shared wireless communication medium for use by multiple client devices also referred to as wireless stations (STAs), and/or a wireless personal area network (WPAN) conforming to Bluetooth Special Interest Group (SIG) specifications may be formed to exchange data between fixed and mobile devices over relatively short distances. As the demand for mobile broadband access and other wireless technologies continues to increase, further improvements in various radio access technologies may be implemented, and other radio access technologies may be introduced, to further advance the evolution of wireless technologies.

### SUMMARY

Some aspects described herein relate to a method of wireless communication performed by a user equipment (UE). The method may include performing a crest factor reduction on a radio frequency (RF) waveform in multiple passes, wherein the multiple passes each include: a clipping operation to reduce a peak-to-average power ratio (PAPR) associated with the RF waveform according to a threshold; and a filtering operation to remove at least a portion of out-of-band emission from the clipped RF waveform. The method may include transmitting the RF waveform over a wireless channel, wherein the RF waveform transmitted over the wireless channel satisfies a spectral mask.

Some aspects described herein relate to an apparatus for wireless communication at a UE. The apparatus may include one or more memories and one or more processors coupled to the one or more memories. The one or more processors may be configured to perform a crest factor reduction on an RF waveform in multiple passes, wherein the multiple passes each include: a clipping operation to reduce a PAPR associated with the RF waveform according to a threshold; and a filtering operation to remove at least a portion of out-of-band emission from the clipped RF waveform. The one or more processors may be configured to transmit the RF waveform over a wireless channel, wherein the RF waveform transmitted over the wireless channel satisfies a spectral mask.

Some aspects described herein relate to a non-transitory computer-readable medium that stores a set of instructions for wireless communication by a UE. The set of instructions, when executed by one or more processors of the UE, may cause the UE to perform a crest factor reduction on an RF waveform in multiple passes, wherein the multiple passes each include: a clipping operation to reduce a PAPR associated with the RF waveform according to a threshold; and a filtering operation to remove at least a portion of out-of-band emission from the clipped RF waveform. The set of instructions, when executed by one or more processors of the UE, may cause the UE to transmit the RF waveform over a wireless channel, wherein the RF waveform transmitted over the wireless channel satisfies a spectral mask.

Some aspects described herein relate to an apparatus for wireless communication. The apparatus may include means for performing a crest factor reduction on an RF waveform in multiple passes, wherein the multiple passes each include: a clipping operation to reduce a PAPR associated with the RF waveform according to a threshold; and a filtering operation to remove at least a portion of out-of-band emission from the clipped RF waveform. The apparatus may include means for transmitting the RF waveform over a wireless channel, wherein the RF waveform transmitted over the wireless channel satisfies a spectral mask.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless network, in accordance with the present disclosure.

FIG. 2 is a diagram illustrating an example network node in communication with a user equipment (UE) in a wireless network, in accordance with the present disclosure.

FIG. 3 is a diagram illustrating an example of a transmit (Tx) chain and a receive (Rx) chain of a wireless device, in accordance with the present disclosure.

FIG. 4 is a diagram illustrating an example of a spectral mask, in accordance with the present disclosure.

FIG. 5 is a diagram illustrating an example of crest factor reduction (CFR), in accordance with the present disclosure.

FIGS. 6A-6B are diagrams illustrating examples associated with a mask-compliant radio frequency (RF) power enhancement using multi-pass CFR, in accordance with the present disclosure.

FIG. 7 is a flowchart illustrating an example process performed, for example, by a UE in accordance with the present disclosure.

FIG. 8 is a diagram of an example apparatus for wireless communication in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

As described herein, crest factor reduction (CFR) or peak-to-average-power ratio (PAPR) reduction is important to ensure efficient, reliable, and high-quality wireless communication systems. For example, because power amplifiers often operate at a relatively low average power, a signal with a high PAPR may reduce overall efficiency. In addition, a high PAPR may consume more battery power in a mobile device, may cause excessive heat dissipation necessitating more robust cooling solutions, may increase interference, and/or may result in higher out-of-band emissions that may result in non-compliance with spectral masks or other limits on spectral emissions that are defined in wireless communication standards and/or regulations. In addition, reducing the PAPR of a radio frequency (RF) waveform may reduce an extent to which an envelope of the RF waveform saturates a power amplifier, which may allow for wireless transmission with increased mask-compliant power. Accordingly, CFR or PAPR reduction techniques are often used to reduce the PAPR associated with an RF waveform as much as possible. For example, in a clip and filter algorithm, the RF waveform may first be clipped to reduce the amplitude of the crests, and then filtered to eliminate distortion that may fall outside a channel and potentially cause the RF waveform to fail to comply with a spectral mask even before any distortion from the power amplifier is added to the signal. However, when out-of-band emissions are filtered from the clipped RF waveform, the peak of the RF waveform increases to a level that is below the initial RF waveform, but much higher than the level that was used to clip the initial RF waveform. As a result, the extent to which the PAPR of an RF waveform can be reduced using clip and filter techniques is limited by the need to prevent spectral regrowth (e.g., in an analog in-phase/quadrature (IQ) waveform).

Various aspects relate generally to CFR or PAPR reduction techniques that use a multi-pass clip and filter. One or more of the passes may have a dynamic threshold that may vary in each pass and/or according to a modulation and coding scheme (MCS) or other parameters associated with an RF waveform to be transmitted. For example, in contrast to a single clip and filter pass, where a PAPR increases after out-of-band emissions or distortion components are removed from a clipped RF waveform even if the RF waveform is heavily or aggressively clipped, some aspects described herein relate to multi-pass clip and filter techniques in which each successive pass conditions an envelope and reduces the PAPR of an RF waveform. In this way, by clipping an RF waveform according to an envelope magnitude (e.g., jointly clipping in-phase (I) and quadrature (Q) amplitudes), the multi-pass CFR or PAPR reduction techniques described herein may introduce only AM-AM distortion representing a shift in relative amplitudes (e.g., in contrast to traditional clip and filter techniques that separately operate on individual I and Q amplitudes, which introduces AM-AM distortion in addition to vector rotation and an arbitrary AM-PM distortion representing phase deviations caused by amplitude variations). In this way, the multi-pass clip and filter techniques described herein may allow a greater CFR for a given PAPR (e.g., where the crest factor is the peak amplitude divided by the root mean square (RMS) amplitude, and the PAPR is the peak power (or amplitude squared) divided by the average power (or RMS amplitude squared), which are equivalent when expressed in decibels (dB)). Furthermore, in some aspects, the multi-pass clip and filter techniques described herein may use different clipping thresholds and/or filters per pass or clipping stage, where earlier clipping stages may use a selective filter to prevent out-of-band spectral regrowth (e.g., preventing non-compliance with a spectral mask) and a final stage may use a less selective or more flexible filter that allows some out-of-band distortion energy (but not enough to violate a spectral mask), which may enable a greater PAPR reduction.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) user equipment (UE) functionality, industrial connectivity, multiple-subscriber implementations, high-precision positioning, RF sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

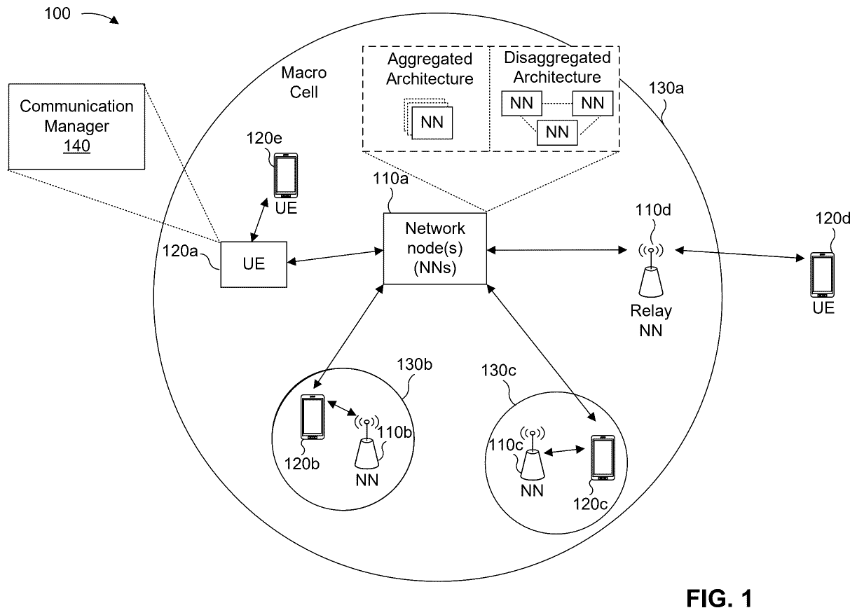

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long Term Evolution (LTE) and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may perform a CFR on an RF waveform in multiple passes, wherein the multiple passes each include: a clipping operation to reduce a PAPR associated with the RF waveform according to a threshold; and a filtering operation to remove at least a portion of out-of-band emission from the clipped RF waveform. In some aspects, the communication manager 140 may transmit the RF waveform over a wireless channel, wherein the RF waveform transmitted over the wireless channel satisfies a spectral mask. Additionally, or alternatively, the communication manager 140 may perform one or more other operations described herein.

As indicated above, FIG. 1 is provided as an example. Other examples may differ from what is described with regard to FIG. 1.

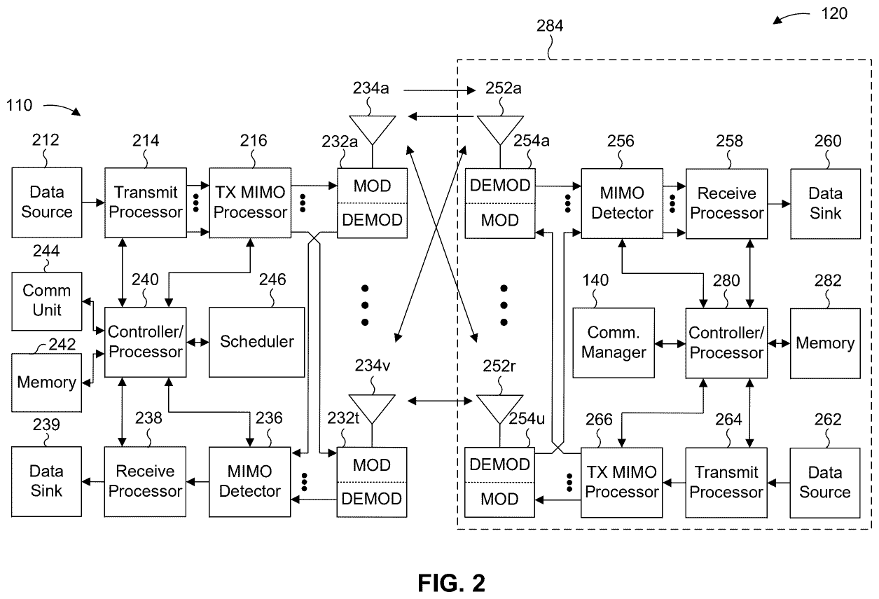

FIG. 2 is a diagram illustrating an example network node 110 in communication with an example UE 120 in a wireless network, in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, and/or a scheduler 246, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors), for example packaged together, associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

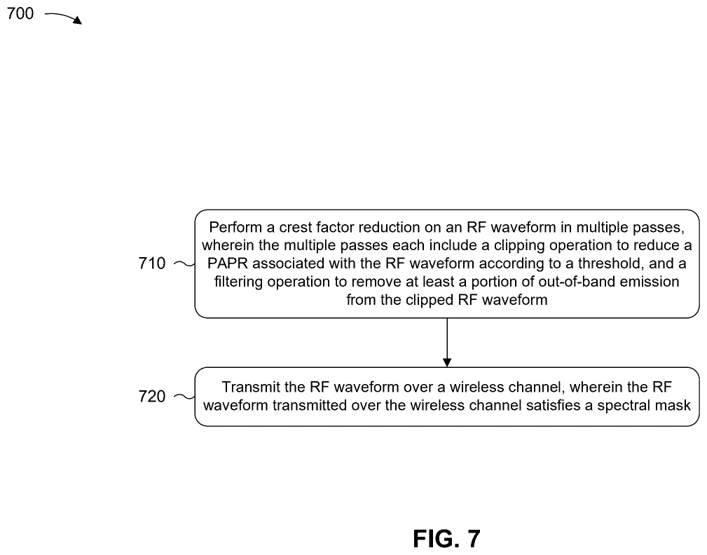

The network node 110, the controller/processor 240 of the network node 110, the UE 120, the controller/processor 280 of the UE 120, or any other component(s) of FIG. 1 or FIG. 2 may implement one or more techniques or perform one or more operations associated with a mask-compliant RF power enhancement using multi-pass CFR, as described in more detail elsewhere herein. For example, the controller/processor 240 of the network node 110, the controller/processor 280 of the UE 120, or any other component(s) of FIG. 2 may perform or direct operations of, for example, process 700 of FIG. 7 or other processes as described herein (alone or in conjunction with one or more other processors). The memory 242 may store data and program codes for the network node 110. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110 or the UE 120 may cause the one or more processors to perform process 700 of FIG. 7 or other processes as described herein. In some examples, executing instructions may include running the instructions, converting the instructions, compiling the instructions, and/or interpreting the instructions, among other examples.

In some aspects, the UE 120 includes means for performing a CFR on an RF waveform in multiple passes, wherein the multiple passes each include: a clipping operation to reduce a PAPR associated with the RF waveform according to a threshold; and a filtering operation to remove at least a portion of out-of-band emission from the clipped RF waveform. In some aspects, the UE 120 includes means for transmitting the RF waveform over a wireless channel, wherein the RF waveform transmitted over the wireless channel satisfies a spectral mask. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

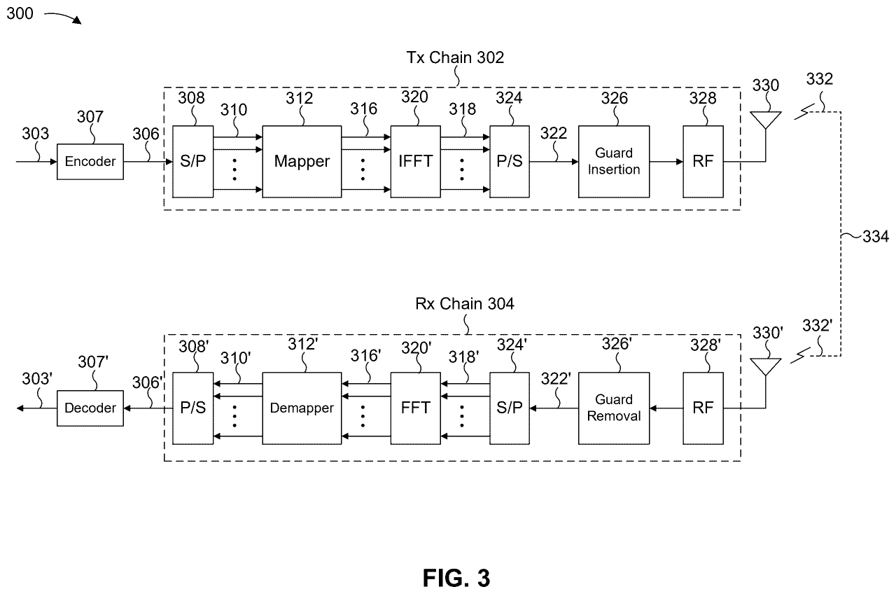

FIG. 3 is a diagram illustrating an example 300 of a transmit (Tx) chain 302 and a receive (Rx) chain 304 of a wireless device in accordance with the present disclosure. In some aspects, one or more components of Tx chain 302 may be implemented in transmit processor 264, TX MIMO processor 266, modem 254, controller/processor 280, transmit processor 214, TX MIMO processor 216, modem 232, and/or controller/processor 240, as described above in connection with FIG. 2. In some aspects, Tx chain 302 may be implemented in a UE 120 for transmitting data 306 (for example, uplink data, an uplink reference signal, and/or uplink control information to a network node 110 on an uplink channel and/or sidelink data, a sidelink reference signal, and/or sidelink control information to another UE 120 on a sidelink channel). Additionally or alternatively, Tx chain 302 may be implemented in a network node 110 for transmitting data 306 (for example, downlink data, a downlink reference signal, and/or downlink control information to a UE 120 on a downlink channel).

An encoder 307 may alter a signal (for example, a bitstream) 303 into data 306. Data 306 to be transmitted is provided from encoder 307 as input to a serial-to-parallel (S/P) converter 308. In some aspects, S/P converter 308 may split the transmission data into N parallel data streams 310.

The N parallel data streams 310 may then be provided as input to a mapper 312. Mapper 312 may map the N parallel data streams 310 onto N constellation points. The mapping may be done using a modulation constellation, such as binary phase-shift keying (BPSK), quadrature phase-shift keying (QPSK), 8 phase-shift keying (8PSK), and/or quadrature amplitude modulation (QAM). Thus, mapper 312 may output N parallel symbol streams 316, each symbol stream 316 corresponding to one of N orthogonal subcarriers of an iFFT component 320. The N parallel symbol streams 316 are represented in the frequency domain and may be converted into N parallel time domain sample streams 318 by iFFT component 320.

In some aspects, N parallel modulations in the frequency domain correspond to N modulation symbols in the frequency domain, which are equal to N mapping and N-point iFFT in the frequency domain, which are equal to one (useful) OFDM symbol in the time domain, which are equal to N samples in the time domain. One OFDM symbol in the time domain, Ns, is equal to Ncp (the number of guard samples per OFDM symbol)+N (the number of useful samples per OFDM symbol).

The N parallel time domain sample streams 318 may be converted into an OFDM/OFDMA symbol stream 322 by a parallel-to-serial (P/S) converter 324. A guard insertion component 326 may insert a guard interval between successive OFDM/OFDMA symbols in the OFDM/OFDMA symbol stream 322. The output of guard insertion component 326 may then be upconverted to a desired transmit frequency band by an RF front end 328. An antenna 330 may then transmit the resulting signal 332.

In some aspects, Rx chain 304 may utilize OFDM/OFDMA. In some aspects, one or more components of Rx chain 304 may be implemented in receive processor 258, MIMO detector 256, modem 254, controller/processor 280, receive processor 238, MIMO detector 236, modem 232, and/or controller/processor 240, as described above in connection with FIG. 2. In some aspects, Rx chain 304 may be implemented in a UE 120 for receiving data 306 (for example, downlink data, a downlink reference signal, and/or downlink control information from a network node 110 on a downlink channel). Additionally or alternatively, Rx chain 304 may be implemented in a network node 110 for receiving data 306 (for example, uplink data, an uplink reference signal, and/or uplink control information from a UE 120 on an uplink channel).

A transmitted signal 332 is shown traveling over a wireless channel 334 from Tx chain 302 to Rx chain 304. When a signal 332′ is received by an antenna 330′, the received signal 332′ may be downconverted to a baseband signal by an RF front end 328′. A guard removal component 326′ may then remove the guard interval that was inserted between OFDM/OFDMA symbols by guard insertion component 326.

The output of guard removal component 326′ may be provided to an S/P converter 324′. The output may include an OFDM/OFDMA symbol stream 322′, and S/P converter 324′ may divide the OFDM/OFDMA symbol stream 322′ into N parallel time-domain symbol streams 318′, each of which corresponds to one of the N orthogonal subcarriers. An FFT component 320′ may convert the N parallel time-domain symbol streams 318′ into the frequency domain and output N parallel frequency-domain symbol streams 316′.

A demapper 312′ may perform the inverse of the symbol mapping operation that was performed by mapper 312, thereby outputting N parallel data streams 310′. A P/S converter 308′ may combine the N parallel data streams 310′ into a single data stream 306′. Ideally, data stream 306′ corresponds to data 306 that was provided as input to Tx chain 302. Data stream 306′ may be decoded into a decoded data stream 303′ by decoder 307′.

The number and arrangement of components shown in FIG. 3 are provided as an example. In practice, there may be additional components, fewer components, different components, or differently arranged components than those shown in FIG. 3. Furthermore, two or more components shown in FIG. 3 may be implemented within a single component, or a single component shown in FIG. 3 may be implemented as multiple, distributed components. Additionally or alternatively, a set of components (for example, one or more components) shown in FIG. 3 may perform one or more functions described as being performed by another set of components shown in FIG. 3.

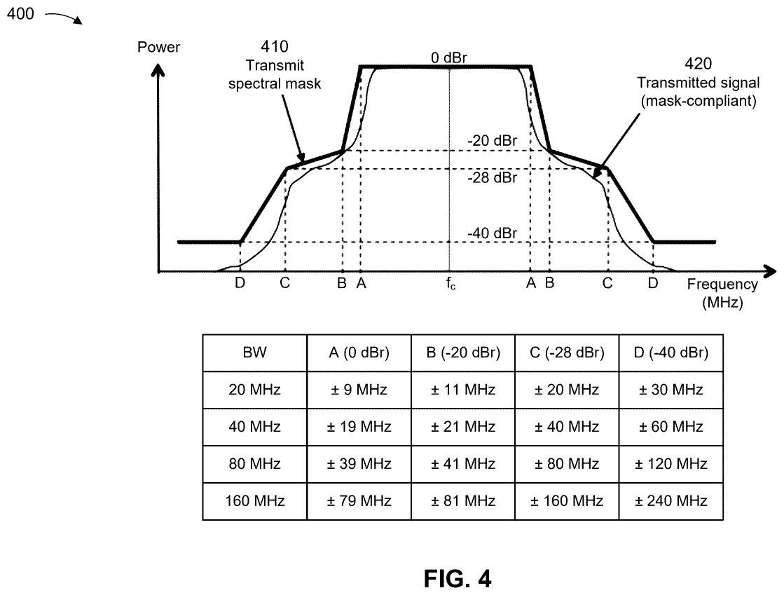

FIG. 4 is a diagram illustrating an example 400 of a spectral mask, in accordance with the present disclosure. In particular, as described herein, a spectral mask (also known as a channel mask or a transmission mask) defines an allowed spectral power distribution in a specified frequency bandwidth (e.g., to reduce adjacent channel interference (ACI) by limiting spurious (e.g., out-of-band) emissions or radiation at frequencies beyond the specified frequency bandwidth). Regulatory bodies, such as the Federal Communications Commission (FCC) in the United States, 3GPP, the European Telecommunications Standards Institute (ETSI), the Institute of Electrical and Electronics Engineers (IEEE), and/or the International Telecommunication Union (ITU), generally specify spectral masks that regulate an amount of power that a transmitter can emit at a center frequency (f_{c}) and at given frequency points (called offsets) on both sides of the center frequency. In particular, a transmitted signal is mask-compliant (e.g., satisfies or otherwise complies with a spectral mask) when a spectral density of the transmitted signal falls within the spectral mask. When the transmitted signal has a spectral density that is outside (e.g., exceeds) the spectral mask, the transmitted signal is non-compliant due to out-of-band emissions that may cause signal interference or signal jamming to other signals, For example, FIG. 4 illustrates an IEEE-specified spectral mask 410 for WLAN communications (commonly known as “Wi-Fi”), which defines a permitted power distribution across each channel. Although the spectral mask 410 illustrated in FIG. 4 applies to WLAN or Wi-Fi communications, spectral masks may be similarly defined for other wireless technologies. As shown in FIG. 4, the spectral mask 410 requires a transmitted WLAN signal 420 to be attenuated by 0 dBr (decibels (dB) relative to a maximum spectral density or peak amplitude) at ±9 MHz from the center frequency for a 20 MHz bandwidth, ±19 MHz from the center frequency for a 40 MHz bandwidth, ±39 MHz from the center frequency for an 80 MHz bandwidth, or ±79 MHz from the center frequency for a 160 MHz bandwidth. Furthermore, the spectral mask 410 requires that the transmitted signal 420 be attenuated a minimum of −20 dBr at ±11 MHz from the center frequency for a 20 MHz bandwidth, ±21 MHz from the center frequency for a 40 MHz bandwidth, ±41 MHz from the center frequency for an 80 MHz bandwidth, or ±81 MHz from the center frequency for a 160 MHz bandwidth. As further shown in FIG. 4, the spectral mask 410 also requires attenuating the transmitted signal 420 a minimum of −28 dBr at ±20 MHz from the center frequency for a 20 MHz bandwidth, ±40 MHz from the center frequency for a 40 MHz bandwidth, ±80 MHz from the center frequency for an 80 MHz bandwidth, or ±160 MHz from the center frequency for a 160 MHz bandwidth, and by a minimum of −40 dBr at ±30 MHz from the center frequency for a 20 MHz bandwidth, ±60 MHz from the center frequency for a 40 MHz bandwidth, ±120 MHz from the center frequency for an 80 MHz bandwidth, or ±240 MHz from the center frequency for a 160 MHz bandwidth. Accordingly, as shown in FIG. 4, the transmitted signal 420 is mask-compliant (e.g., satisfies the requirements of the spectral mask 410) because the power of the signal does not exceed any of the specified limits across the applicable range of frequencies. Furthermore, as described herein, the attenuation requirements shown in FIG. 4 and described herein are to be considered examples only, and WLAN communications may be subject to attenuation requirements for other channel bandwidths (e.g., 320 MHz or 640 MHz).

Accordingly, in cases where an RF waveform (e.g., corresponding to a WLAN signal, an OFDM signal, or another suitable signal) fails to satisfy or otherwise comply with a spectral mask due to out-of-band emissions exceeding the specified limits, a transmitter may employ a filter to attenuate the out-of-band emissions and bring the RF waveform within the spectral mask limits. For example, the filter may be a band-pass filter that confines the RF waveform within a certain frequency range, a low-pass filter to limit higher frequency components, or the like, and the filter may be implemented in a digital domain using various parameters (e.g., cutoff frequencies, roll-off rates, or the like) that are designed to match the spectral mask requirements. For example, the filter is generally implemented to ensure that the power levels of the RF waveform outside a desired frequency range (relative to the center frequency) are sufficiently attenuated to satisfy the limits associated with the spectral mask.

As indicated above, FIG. 4 is provided as an example. Other examples may differ from what is described with regard to FIG. 4.

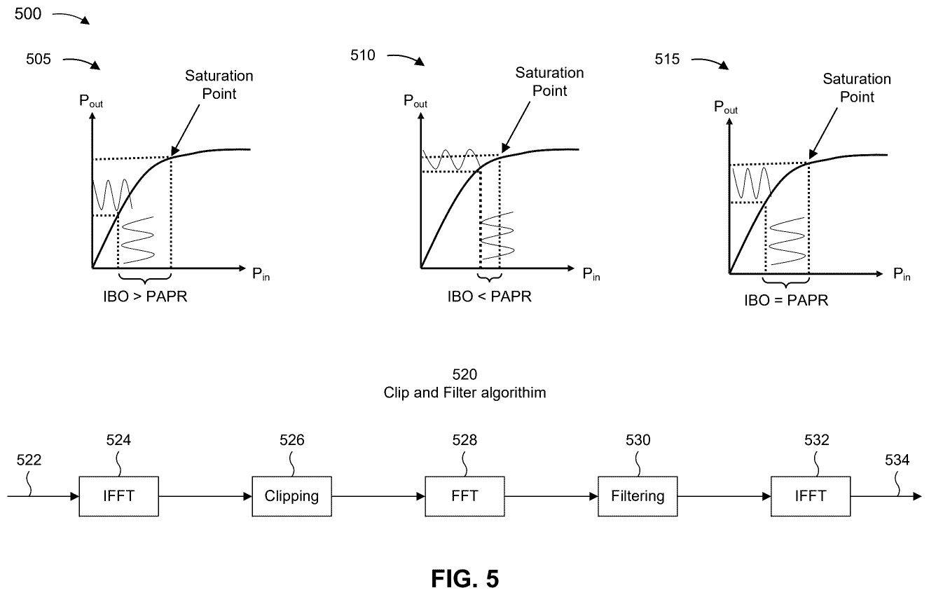

FIG. 5 is a diagram illustrating an example 500 of CFR, in accordance with the present disclosure. More particularly, as described herein, a crest factor is a parameter of a waveform that represents a ratio between peak values in the waveform and an average value of the waveform. For example, for an RF waveform, the crest factor is a dB difference between a peak power and an RMS power of the RF waveform, and is effectively the same as, or similar to, a PAPR of the RF waveform when expressed in dB.

As described herein, CFR or PAPR reduction is important to ensure efficient, reliable, and high-quality wireless communication systems. For example, a wireless transmitter may employ a power amplifier to amplify a transmit power of a transmitted signal, and the power amplifier may experience non-linear behavior at high input powers (Pᵢₙ). For example, an output power (Pₒᵤₜ) of a power amplifier may have a linear relationship with low input powers, and a non-linear relationship with high input powers. The non-linear relationship may result in distortion (e.g., in-band distortion and/or out-of-band distortion) of a signal, as well as error vector magnitude (EVM) degradation at a receiver of the signal. Accordingly, to avoid non-linearity in a power amplifier, the power amplifier may operate at a mean input power that is less than a saturation point (e.g., an input power above which the input power and the output power have a non-linear relationship). In some cases, an input power used for a power amplifier may be correlated with the PAPR associated with a signal. For example, if a signal is associated with a PAPR of x dB, an input backoff (IBO) from the saturation point may be x dB, such that peaks of the input power do not exceed the saturation point.

However, using an IBO may affect performance of a power amplifier. For example, as shown by reference number 505, a transmit power used by a transmitter may be overly restricted if an IBO is greater than a PAPR, and the transmitter may transmit the signal with insufficient power to reach a receiver. Alternatively, as shown by example 510, using an IBO that is less than the PAPR may cause peaks of a signal to exceed the saturation point and result in distortion. Alternatively, as shown by example 515, the IBO may equal the PAPR, which may result in the transmitter using a maximum transmit power that does not cause distortion. However, in cases where the PAPR is large, the maximum transmit power may be insufficient to reach a receiver or otherwise satisfy a power requirement. Accordingly, because power amplifiers operate at a relatively low average power in some configurations, a signal with a high PAPR may reduce overall efficiency. In addition, a high PAPR may consume more battery power in a mobile device, may cause excessive heat dissipation necessitating more robust cooling solutions, may increase interference, and/or may result in higher out-of-band emissions that may result in non-compliance with spectral masks or other limits on spectral emissions that are defined in wireless communication standards and/or regulations.

Accordingly, in order to reduce the PAPR of an RF waveform (e.g., a WLAN signal, an OFDM signal, or another suitable wireless signal), CFR or PAPR reduction techniques may be used to reduce the PAPR associated with the RF waveform as much as possible. For example, as shown in FIG. 5, a clip and filter algorithm 520 may be used to reduce a PAPR for an RF waveform. For example, an RF waveform 522 may be input to the clip and filter algorithm 520, and an iFFT 524 may be applied to the RF waveform 522 to convert the RF waveform 522 to a time domain. As further shown in FIG. 5, a clipping operation 526 may be performed to limit the amplitude of the RF waveform 522 to a threshold, where any peaks in the RF waveform 522 that exceed the threshold are “clipped” to the threshold level. Although the clipping operation 526 may effectively reduce the PAPR of the RF waveform 522, the clipping operation 526 may introduce in-band distortion and/or out-of-band emissions that may degrade the signal quality, affect adjacent channels, and/or fail to comply with requirements of a spectral mask. Accordingly, to mitigate the out-of-band emissions introduced by the clipping operation 526, the clipped RF waveform 522 may be passed through a filter. For example, an FFT 528 may be applied to the clipped RF waveform 522 to transform the clipped RF waveform 522 back to the frequency domain, and a filtering operation 530 may then be applied to ensure that the RF waveform 522 satisfies spectral limits (e.g., a spectral mask). Another iFFT 532 may then be applied to the clipped and filtered RF waveform 522 to generate an output signal 534 to be transmitted.

However, the filtering operation 530 may cause peak regrowth, or spectral regrowth, that partially negates the PAPR reduction achieved by the clipping operation 526, which may pose challenges in applications that demand a high UE transmit power. For example, a higher UE transmit power enables an RF signal to penetrate buildings and obstacles more effectively and helps to maintain connectivity over larger distances in rural and remote areas where network infrastructure may be sparse. In addition, a higher UE transmit power can allow a higher MCS to be used, which may increase throughput, and/or may enable advanced applications such as video streaming and online gaming. In another example, increased RF power from a WLAN or Wi-Fi transceiver in a UE may enable use cases such as mobile hotspots. In this example, IEEE standards provide an EVM limit for each supported modulation, from MCS13 (4096 QAM) to MCS0 (QPSK). For example, the EVM requirement for QPSK is relatively modest at −5 dB, which may be associated with a key performance indicator (KPI) for mask-compliant power for MCS0 of 21 decibel-milliwatts (dBm) at a power amplifier output. However, higher MCS0 mask-compliant power may be needed for various use cases, such as 25 dBm for 5 GHz chains or 26 dBm for 2.4 GHz chains.

Accordingly, one way to increase the available mask-compliant power is to reduce the PAPR of the RF waveform (e.g., using the clip and filter algorithm 520 or a similar algorithm), which reduces the extent to which the envelope of the RF waveform saturates the power amplifier. For example, as described herein, the RF waveform may first be clipped to reduce the amplitude of the crests, and then filtered to eliminate distortion that may fall outside a channel and potentially cause the RF waveform to fail to comply with a spectral mask even before any distortion from the power amplifier is added to the signal. Accordingly, the extent to which the PAPR of an RF waveform can be reduced using clip and filter techniques is limited by the need to prevent spectral regrowth in an analog IQ waveform. For example, when the out-of-band emissions are filtered from the clipped RF waveform, the peak of the RF waveform increases to a level that is below the initial RF waveform, but much higher than the level that was used to clip the initial RF waveform (e.g., limiting an achievable PAPR reduction to 4-5 dB, where the initial RF waveform has a PAPR of about 11 dB and the final clipped and filtered waveform has a PAPR of about 6 dB).

Various aspects relate generally to CFR or PAPR reduction techniques that use a multi-pass clip and filter. One or more of the passes may have a dynamic threshold that may vary in each pass and/or according to an MCS or other parameters associated with an RF waveform to be transmitted. For example, in contrast to a single clip and filter pass, where a PAPR increases after out-of-band emissions or distortion components are removed from a clipped RF waveform even if the RF waveform is heavily or aggressively clipped, some aspects described herein relate to multi-pass clip and filter techniques in which each successive pass conditions an envelope and reduces the PAPR of an RF waveform. In this way, by clipping an RF waveform according to an envelope magnitude, the multi-pass CFR or PAPR reduction techniques described herein may introduce only AM-AM distortion representing a shift in relative amplitudes (e.g., in contrast to traditional clip and filter techniques that operate on individual I and Q amplitudes, which introduces AM-AM distortion in addition to vector rotation and an arbitrary AM-PM distortion representing phase deviations caused by amplitude variations). In this way, the multi-pass clip and filter techniques described herein may allow a greater CFR for a given PAPR (e.g., where the crest factor is the peak amplitude divided by the RMS amplitude, and the PAPR is the peak power (or amplitude squared) divided by the average power (or RMS amplitude squared), which are equivalent when expressed in dB). Furthermore, in some aspects, the multi-pass clip and filter techniques described herein may use different clipping thresholds and/or filters per pass or clipping stage, where earlier clipping stages may use a selective filter to prevent out-of-band spectral regrowth (e.g., preventing non-compliance with a spectral mask) and a final stage may use a less selective or more flexible filter that allows some out-of-band distortion energy (but not enough to violate a spectral mask), which may enable a greater PAPR reduction.

As indicated above, FIG. 5 is provided as an example. Other examples may differ from what is described with regard to FIG. 5.

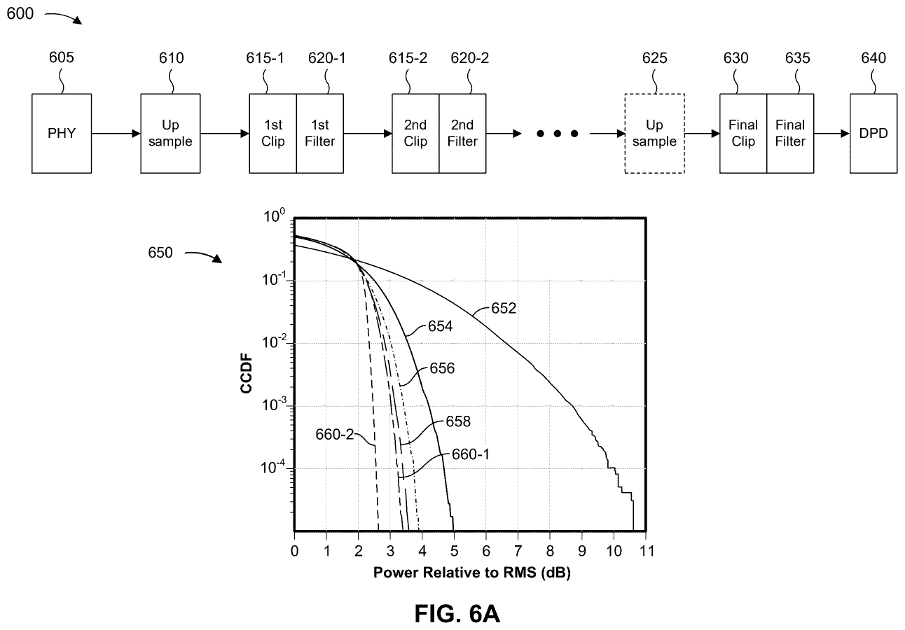

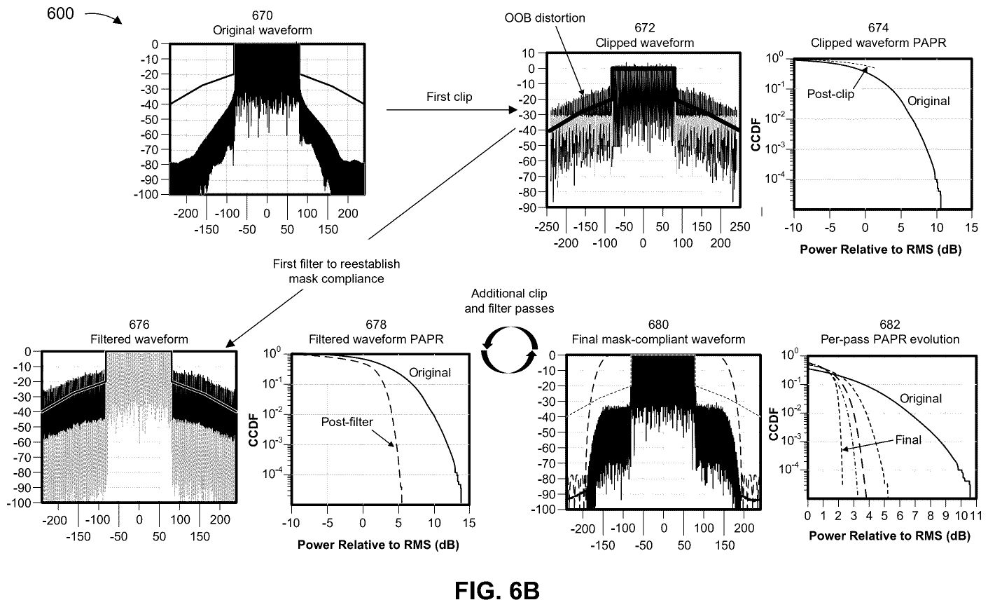

FIGS. 6A-6B are diagrams illustrating an example 600 associated with a mask-compliant RF power enhancement using multi-pass CFR, in accordance with the present disclosure. In some aspects, as described herein, the multi-pass CFR may be implemented in a UE 120 or another suitable transmitter to increase a mask-compliant power for an RF transmission. For example, as shown in FIG. 6A, a PHY block 605 may output an RF waveform (e.g., a WLAN or Wi-Fi waveform, an OFDM waveform, or another suitable waveform) in a baseband, and the multi-pass CFR may include various clip and filter stages between the PHY block 605 and a digital predistortion (DPD) block 640 to reduce a PAPR of the RF waveform in multiple passes. As described herein, an output from the DPD block 640 may be provided to a digital-to-analog converter (DAC) (not shown in FIG. 6A). Accordingly, in some aspects, the PHY block 605, the DPD block 640, and the various clip and filter stages between the PHY block 605 and the DPD block 640 may be implemented in one or more components that process a signal in a digital domain, such as the transmit processor 264, the TX MIMO processor 266, the modem 254, and/or the controller/processor 280 shown in FIG. 2, the RF front end 328 shown in FIG. 3, or the like.

For example, as shown in FIG. 6A, and by reference number 610, the RF waveform may initially be up-sampled to prepare the RF waveform for the clip and filter operations to be performed on the RF waveform. For example, in some aspects, the RF waveform output by the PHY block 605 may be up-sampled such that the initial clip and filter operations can be performed at a sample rate that is below a digital-to-analog (DAC) conversion rate. In this way, enabling the initial clip and filter operations at a sample rate below the DAC conversion rate may reduce a number of filter taps.

As further shown in FIG. 6A, a first CFR pass may include a first clipping operation 615-1 and a first filter operation 620-1. As described herein, the first clipping operation 615-1 may be performed using a threshold that may have a configurable value based on an MCS associated with the RF waveform (e.g., the threshold may have different values when the RF waveform is associated with MCS0, MCS1, MCS2, and so on). Additionally, or alternatively, the threshold may have a configurable value that is associated with an iteration of the clipping operation 615-1. For example, in some aspects, the threshold may have an initial value (e.g., 0.2) to aggressively or heavily clip the initial RF waveform. For example, in some aspects, the first clipping operation 615-1 may be performed based on an envelope magnitude of the RF waveform such that any peaks in the RF waveform that exceed the threshold are “clipped” to the threshold level. For example, referring to FIG. 6B, reference number 670 depicts an example of an original RF waveform that may be output by the PHY block, which is initially compliant with a spectral mask (e.g., out-of-band emissions do not exceed a specified level associated with the spectral mask, which is an IEEE spectral mask in the illustrated example).

Accordingly, as further shown by reference number 672, applying the first clipping operation 615-1 to the original RF waveform results in a clipped waveform, where the first clipping operation 615-1 operates on an envelope of the original waveform to condition the RF waveform and reduce the peak power according to the threshold. In this way, by operating on the envelope magnitude of the RF waveform, the first clipping operation 615-1 may result in a greater CFR for a given PAPR reduction relative to clipping techniques that operate on individual I and Q amplitudes. For example, as shown by reference number 674, the original RF waveform has a PAPR that exceeds 10 dB, which is reduced to about 1 dB after the first clipping operation 615-1. However, as shown by reference number 672, the hard stop on the first clipping operation 615-1 results in the clipped waveform having out-of-band emissions or distortion energy and spectral splatter that results in the clipped RF waveform failing to comply with the spectral mask. For example, as shown, the clipped RF waveform has out-of-band emissions that exceed the maximum level that are allowed by the spectral mask associated with the RF waveform.

Accordingly, as further shown in FIG. 6A and FIG. 6B, a first filtering operation 620-1 may be performed to reestablish compliance with the spectral mask.

For example, in some aspects, the first filtering operation 620-1 may use a selective filter to remove out-of-band emissions and prevent out-of-band spectral regrowth (e.g., preventing non-compliance with an IEEE, 3GPP, ETSI, Bluetooth, ITU, or other suitable spectral mask). In particular, as shown by reference number 676 in FIG. 6B, the first filtering operation 620-1 may condition an envelope of the RF waveform such that out-of-band emissions do not accumulate in the RF waveform and the filtered RF waveform satisfies the spectral mask. However, as shown by reference number 678, the first filtering operation 620-1 may result in the filtered RF waveform having a higher PAPR than the unfiltered RF waveform. For example, as shown, the first filtering operation 620-1 increases the PAPR of the RF waveform from about 1 dB to about 5 dB. Accordingly, in some aspects, one or more additional clip and filter operations may be applied to the RF waveform to further reduce the PAPR while keeping out-of-band emissions low (e.g., within the limits of the spectral mask).

For example, as shown in FIG. 6A, a second clipping operation 615-2 may be performed on the clipped and filtered RF waveform output from the first clip and filter pass, where the second clipping operation 615-2 may generally be similar to the first clipping operation 615-1 except that the value of the threshold may be varied (e.g., reduced from 0.2 to 0.18) to clip the RF waveform less heavily or aggressively. In addition, the second clipping operation 615-2 may be followed by a second filtering operation 620-2 that uses the selective filter to remove out-of-band emissions and prevent out-of-band spectral regrowth. Accordingly, the multiple passes of the CFR may generally include one or more passes of a clipping operation 615 and a filtering operation 620 being performed, with each successive pass of the clipping operation 615 reducing the PAPR of the RF waveform and each successive pass of the filtering operation 620 conditioning the envelope of the RF waveform to reestablish mask compliance and prevent out-of-band emissions from accumulating. In general, the number of passes of the clipping operation 615 and the filtering operation 620 may be configurable based on an MCS, based on a desired PAPR reduction, or the like.

In some aspects, as shown by reference number 625, after performing one or more earlier passes of the clipping operation 615 and the filtering operation 620, the RF waveform may be up-sampled to prepare the RF waveform for a final clip operation 630 and a final filter operation 635. For example, in some aspects, the final clip operation 630 and the final filter operation 635 may be performed at a higher sample rate than the one or more earlier passes of the clipping operation 615 and the filtering operation 620 that were performed at a sample rate below the DAC sample rate. For example, in some aspects, the final clip operation 630 and the final filter operation 635 may be performed at the DAC sample rate, to allow for some out-of-band emissions or distortion and a greater PAPR reduction. For example, in some aspects, the final clipping operation 630 may be performed with the threshold having a value that is higher than a value used in a last clipping operation 615 in the earlier clip and filter stages. In this way, the final clipping operation 630 may heavily or aggressively clip the RF waveform to reduce the PAPR as much as possible prior to transmission. Furthermore, in some aspects, the final filter operation 635 may be performed using a mask-compliant filter that may be less selective (e.g., wider or looser) to allow some out-of-band emissions while still ensuring that the final RF waveform is compliant with the spectral mask. For example, in some aspects, the final filter operation 635 may generally be regulatory and coexistence aware, to ensure that the final RF waveform is compliant with standardized or regulated spectral masks, to ensure compliance with limits on out-of-band or spurious emissions in protected bands (e.g., when operating near an FCC or ITU protected band, the filter used in the final filter operation 635 may be configured to prevent distortion components from being generated in the final RF waveforms within the protected frequencies), and/or to enable coexistence in a channel where another co-sited system may be operating, among other examples. For example, as shown by reference number 680 in FIG. 6B, the final mask-compliant RF waveform may include some out-of-band emissions or distortion energy while remaining within the limits of the applicable spectral mask. Alternatively, in some aspects, the final filter operation 635 may use a selective filter that removes all out-of-band emissions from the final RF waveform, which may result in a lesser PAPR reduction than using the more flexible mask-compliant filter. The final mask-compliant RF waveform may then be output to the DPD block 640, which may further process the final RF waveform prior to the processed RF waveform being provided to one or more power amplifiers and transmitted over a wireless channel.

In this way, performing the CFR on the RF waveform in multiple passes, which includes one or more clipping operations 615 and filtering operations 620 that are followed by a final clipping operation 630 and a final filter operation 635, may result in a greater PAPR reduction relative to a single clip and filter pass. For example, as shown by reference number 682, a per-pass PAPR evolution shows a decrease in the PAPR of the RF waveform in each clip and filter pass. Similarly, reference number 650 in FIG. 6A depicts the per-pass PAPR evolution in more detail, for a specific example where three early clip and filter passes are followed by a fourth (final) clip and filter operation. For example, curve 652 corresponds to a PAPR of the original waveform, curve 654 corresponds to a PAPR of the waveform after a first clip and filter pass, curve 656 corresponds to a PAPR of the waveform after a second clip and filter pass, and curve 658 corresponds to a PAPR of the waveform after a third clip and filter pass.

Furthermore, curve 660-1 corresponds to a PAPR of the waveform where the final filter operation is performed using a selective filter that removes all out-of-band emissions, and curve 660-2 corresponds to a PAPR of the waveform where the final filter operation is performed using a less selective mask-compliant filter that allows some out-of-band emissions, which results in a greater PAPR reduction relative to curve 660-1.

As indicated above, FIGS. 6A-6B are provided as an example. Other examples may differ from what is described with regard to FIGS. 6A-6B. For example, although FIGS. 6A-6B provide an example with four clip and filter passes, the multi-pass CFR techniques may generally be performed in N passes, where N is an integer having a value greater than or equal to 2. Furthermore, in some aspects, the multi-pass CFR may generally use a selective filter (e.g., at a sample rate below a DAC sample rate) to eliminate out-of-band distortion components and prevent spectral growth through pass N−1, and pass N may use a less selective regulatory and coexistence aware filter (e.g., at a higher sample rate than the first N−1 passes, such as the DAC sample rate).

FIG. 7 is a diagram illustrating an example process 700 performed, for example, at a UE or an apparatus of a UE, in accordance with the present disclosure. Example process 700 is an example where the apparatus or the UE (e.g., UE 120) performs operations associated with mask-compliant RF power enhancement using multi-pass CFR.

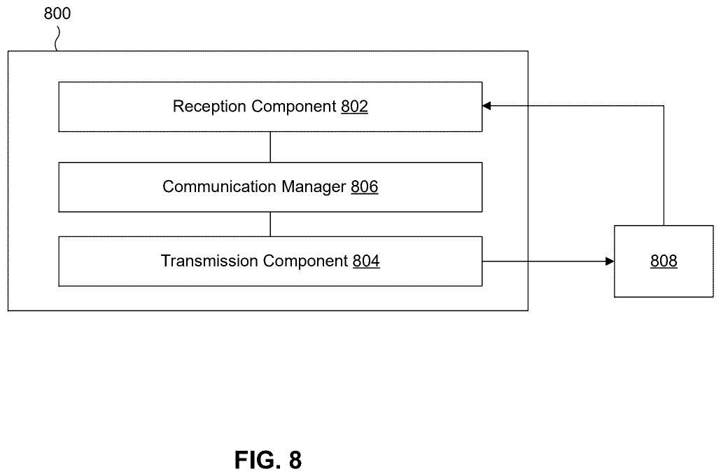

As shown in FIG. 7, in some aspects, process 700 may include performing a CFR on an RF waveform in multiple passes, wherein the multiple passes each include: a clipping operation to reduce a PAPR associated with the RF waveform according to a threshold; and a filtering operation to remove at least a portion of out-of-band emission from the clipped RF waveform (block 710). The threshold may be dynamic. For example, the UE (e.g., using communication manager 806, depicted in FIG. 8) may perform a CFR on an RF waveform in multiple passes, wherein the multiple passes each include: a clipping operation to reduce a PAPR associated with the RF waveform according to a threshold; and a filtering operation to remove at least a portion of out-of-band emission from the clipped RF waveform, as described above.

As further shown in FIG. 7, in some aspects, process 700 may include transmitting the RF waveform over a wireless channel, wherein the RF waveform transmitted over the wireless channel satisfies a spectral mask (block 720). For example, the UE (e.g., using transmission component 804 and/or communication manager 806, depicted in FIG. 8) may transmit the RF waveform over a wireless channel, wherein the RF waveform transmitted over the wireless channel satisfies a spectral mask, as described above.

Process 700 may include additional aspects, such as any single aspect or any combination of aspects described below and/or in connection with one or more other processes described elsewhere herein.

In a first aspect, the clipping operation is performed in each of the multiple passes according to a magnitude of an envelope of the RF waveform.

In a second aspect, alone or in combination with the first aspect, the multiple passes include one or more passes in which the filtering operation applies a filter configured to remove all out-of-band emissions from the clipped RF waveform.

In a third aspect, alone or in combination with one or more of the first and second aspects, the multiple passes include a final pass in which the filtering operation applies a filter configured to not remove some out-of-band emissions from the clipped RF waveform.

In a fourth aspect, alone or in combination with one or more of the first through third aspects, the multiple passes include a final pass in which the filtering operation applies a filter configured to remove out-of-band emissions that fail to comply with the spectral mask from the clipped RF waveform.

In a fifth aspect, alone or in combination with one or more of the first through fourth aspects, the multiple passes include a final pass in which the filtering operation applies a filter configured to remove out-of-band emissions within a protected or restricted frequency band or a channel in which another system is operating.

In a sixth aspect, alone or in combination with one or more of the first through fifth aspects, the multiple passes include a first pass in which the threshold has a first value and a second pass in which the threshold has a second value.

In a seventh aspect, alone or in combination with one or more of the first through sixth aspects, the threshold has a variable value, over the multiple passes, that is based at least in part on an MCS associated with the RF waveform.

In an eighth aspect, alone or in combination with one or more of the first through seventh aspects, the spectral mask is associated with maximum out-of-band emissions for an MCS associated with the RF waveform.

In a ninth aspect, alone or in combination with one or more of the first through eighth aspects, the multiple passes include one or more passes in which the clipping operation and the filtering operation are performed according to a sample rate that is below a DAC sample rate associated with the RF waveform.

In a tenth aspect, alone or in combination with one or more of the first through ninth aspects, the multiple passes include one or more passes in which the clipping operation and the filtering operation are performed at a DAC sample rate associated with the RF waveform.

In an eleventh aspect, alone or in combination with one or more of the first through tenth aspects, the CFR is performed in a baseband associated with the RF waveform.

In a twelfth aspect, alone or in combination with one or more of the first through eleventh aspects, the clipping operation is performed jointly on I and Q amplitudes.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a UE, or a UE may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 140 described in connection with FIG. 1 and/or FIG. 2. As shown, the apparatus 800 may communicate with another apparatus 808, such as a UE or a network node (such as a CU, a DU, an RU, or a base station), using the reception component 802 and the transmission component 804.

In some aspects, the apparatus 800 may be configured to perform one or more operations described herein in connection with FIGS. 6A-6B. Additionally, or alternatively, the apparatus 800 may be configured to perform one or more processes described herein, such as process 700 of FIG. 7. In some aspects, the apparatus 800 and/or one or more components shown in FIG. 8 may include one or more components of the UE described above in connection with FIG. 2 and/or the Tx chain 302 described above in connection with FIG. 3. Additionally, or alternatively, one or more components shown in FIG. 8 may be implemented within one or more components described in connection with FIG. 2 and/or FIG. 3. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, one or more modems, one or more demodulators, one or more MIMO detectors, one or more receive processors, one or more controllers/processors, one or more memories, or a combination thereof, of the UE described above in connection with FIG. 2 and/or one or more components of the Rx chain 304 described above in connection with FIG. 3.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications (such as clipping, filtering, amplification, modulation, digital-to-analog conversion, multiplexing, interleaving, mapping, or encoding, among other examples), and may transmit the processed signals to the apparatus 808. In some aspects, the transmission component 804 may include one or more antennas, one or more modems, one or more modulators, one or more transmit MIMO processors, one or more transmit processors, one or more controllers/processors, one or more memories, or a combination thereof, of the UE described above in connection with FIG. 2 and/or one or more components of the Tx chain 302 described above in connection with FIG. 3. In some aspects, the transmission component 804 may be co-located with the reception component 802 in one or more transceivers.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The communication manager 806 may perform a CFR on an RF waveform in multiple passes, wherein the multiple passes each include: a clipping operation to reduce a PAPR associated with the RF waveform according to a threshold; and a filtering operation to remove at least a portion of out-of-band emission from the clipped RF waveform. The transmission component 804 may transmit the RF waveform over a wireless channel, wherein the RF waveform transmitted over the wireless channel satisfies a spectral mask.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:
Aspect 1: A method of wireless communication performed by a UE, comprising: performing a crest factor reduction on an RF waveform in multiple passes, wherein the multiple passes each include: a clipping operation to reduce a PAPR associated with the RF waveform according to a threshold; and a filtering operation to remove at least a portion of out-of-band emission from the clipped RF waveform; and transmitting the RF waveform over a wireless channel, wherein the RF waveform transmitted over the wireless channel satisfies a spectral mask.
Aspect 2: The method of Aspect 1, wherein the clipping operation is performed in each of the multiple passes according to a magnitude of an envelope of the RF waveform.
Aspect 3: The method of any of Aspects 1-2, wherein the multiple passes include one or more passes in which the filtering operation applies a filter configured to remove all out-of-band emissions from the clipped RF waveform.
Aspect 4: The method of any of Aspects 1-3, wherein the multiple passes include a final pass in which the filtering operation applies a filter configured to not remove some out-of-band emissions from the clipped RF waveform.
Aspect 5: The method of any of Aspects 1-4, wherein the multiple passes include a final pass in which the filtering operation applies a filter configured to remove out-of-band emissions that fail to comply with the spectral mask from the clipped RF waveform.
Aspect 6: The method of any of Aspects 1-5, wherein the multiple passes include a final pass in which the filtering operation applies a filter configured to remove out-of-band emissions within a protected or restricted frequency band or a channel in which another system is operating.
Aspect 7: The method of any of Aspects 1-6, wherein the multiple passes include a first pass in which the threshold has a first value and a second pass in which the threshold has a second value.
Aspect 8: The method of any of Aspects 1-7, wherein the threshold has a variable value, over the multiple passes, that is based at least in part on an MCS associated with the RF waveform.
Aspect 9: The method of any of Aspects 1-8, wherein the spectral mask is associated with maximum out-of-band emissions for an MCS associated with the RF waveform.
Aspect 10: The method of any of Aspects 1-9, wherein the multiple passes include one or more passes in which the clipping operation and the filtering operation are performed according to a sample rate that is below a DAC sample rate associated with the RF waveform.
Aspect 11: The method of any of Aspects 1-10, wherein the multiple passes include one or more passes in which the clipping operation and the filtering operation are performed at a DAC sample rate associated with the RF waveform.
Aspect 12: The method of any of Aspects 1-11, wherein the crest factor reduction is performed in a baseband associated with the RF waveform.
Aspect 13: The method of any of Aspects 1-12, wherein the clipping operation is performed jointly on I and Q amplitudes.
Aspect 14: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-13.
Aspect 15: An apparatus for wireless communication at a device, the apparatus comprising one or more memories and one or more processors coupled to the one or more memories, the one or more processors configured to cause the device to perform the method of one or more of Aspects 1-13.
Aspect 16: An apparatus for wireless communication, the apparatus comprising at least one means for performing the method of one or more of Aspects 1-13.
Aspect 17: A non-transitory computer-readable medium storing code for wireless communication, the code comprising instructions executable by one or more processors to perform the method of one or more of Aspects 1-13.
Aspect 18: A non-transitory computer-readable medium storing a set of instructions for wireless communication, the set of instructions comprising one or more instructions that, when executed by one or more processors of a device, cause the device to perform the method of one or more of Aspects 1-13.
Aspect 19: A device for wireless communication, the device comprising a processing system that includes one or more processors and one or more memories coupled with the one or more processors, the processing system configured to cause the device to perform the method of one or more of Aspects 1-13.
Aspect 20: An apparatus for wireless communication at a device, the apparatus comprising one or more memories and one or more processors coupled to the one or more memories, the one or more processors individually or collectively configured to cause the device to perform the method of one or more of Aspects 1-13.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more. ” Further, as used herein, the article “the” is intended to include one or more items referenced in connection with the article “the” and may be used interchangeably with “the one or more. ” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one. ”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. A method of wireless communication performed by a user equipment (UE), comprising:
performing a crest factor reduction on a radio frequency (RF) waveform in multiple passes, wherein the multiple passes each include:
a clipping operation to reduce a peak-to-average power ratio (PAPR) associated with the RF waveform according to a threshold; and
a filtering operation to remove at least a portion of out-of-band emission from the clipped RF waveform; and
transmitting the RF waveform over a wireless channel, wherein the RF waveform transmitted over the wireless channel satisfies a spectral mask.

2. The method of claim 1, wherein the clipping operation is performed in each of the multiple passes according to a magnitude of an envelope of the RF waveform.

3. The method of claim 1, wherein the multiple passes include one or more passes in which the filtering operation applies a filter configured to remove all out-of-band emissions from the clipped RF waveform.

4. The method of claim 1, wherein the multiple passes include a final pass in which the filtering operation applies a filter configured to not remove some out-of-band emissions from the clipped RF waveform.

5. The method of claim 1, wherein the multiple passes include a final pass in which the filtering operation applies a filter configured to remove out-of-band emissions that fail to comply with the spectral mask from the clipped RF waveform.

6. The method of claim 1, wherein the multiple passes include a final pass in which the filtering operation applies a filter configured to remove out-of-band emissions within a protected or restricted frequency band or a channel in which another system is operating.

7. The method of claim 1, wherein the multiple passes include a first pass in which the threshold has a first value and a second pass in which the threshold has a second value.

8. The method of claim 1, wherein the threshold has a variable value, over the multiple passes, that is based at least in part on a modulation and coding scheme associated with the RF waveform.

9. The method of claim 1, wherein the spectral mask is associated with maximum out-of-band emissions for a modulation and coding scheme associated with the RF waveform.

10. The method of claim 1, wherein the multiple passes include one or more passes in which the clipping operation and the filtering operation are performed according to a sample rate that is below a digital-to-analog conversion sample rate associated with the RF waveform.

11. The method of claim 1, wherein the multiple passes include one or more passes in which the clipping operation and the filtering operation are performed at a digital-to-analog conversion sample rate associated with the RF waveform.

12. The method of claim 1, wherein the crest factor reduction is performed in a baseband associated with the RF waveform.

13. The method of claim 1, wherein the clipping operation is performed jointly on in-phase and quadrature amplitudes.

14. An apparatus for wireless communication at a user equipment (UE), comprising:
one or more memories; and
one or more processors, coupled to the one or more memories, configured to cause the UE to:
perform a crest factor reduction on a radio frequency (RF) waveform in multiple passes, wherein the multiple passes each include:
a clipping operation to reduce a peak-to-average power ratio (PAPR) associated with the RF waveform according to a threshold; and
a filtering operation to remove at least a portion of out-of-band emission from the clipped RF waveform; and
transmit the RF waveform over a wireless channel, wherein the RF waveform transmitted over the wireless channel satisfies a spectral mask.

15. The apparatus of claim 14, wherein the clipping operation is performed in each of the multiple passes according to a magnitude of an envelope of the RF waveform.

16. The apparatus of claim 14, wherein the multiple passes include:
one or more passes in which the filtering operation applies a filter configured to remove all out-of-band emissions from the clipped RF waveform, and
a final pass in which the filtering operation applies a filter configured to not remove some out-of-band emissions from the clipped RF waveform.

17. The apparatus of claim 14, wherein the multiple passes include a final pass in which the filtering operation applies a filter configured to remove one or more of out-of-band emissions that fail to comply with the spectral mask from the clipped RF waveform or out-of-band emissions within a protected or restricted frequency band or a channel in which another system is operating.

18. The apparatus of claim 14, wherein the threshold has a variable value, over the multiple passes, that is based at least in part on a modulation and coding scheme associated with the RF waveform.

19. The apparatus of claim 14, wherein the spectral mask is associated with maximum out-of-band emissions for a modulation and coding scheme associated with the RF waveform.

20. An apparatus for wireless communication, comprising:
means for performing a crest factor reduction on a radio frequency (RF) waveform in multiple passes, wherein the multiple passes each include:
a clipping operation to reduce a peak-to-average power ratio (PAPR) associated with the RF waveform according to a threshold; and
a filtering operation to remove at least a portion of out-of-band emission from the clipped RF waveform; and
means for transmitting the RF waveform over a wireless channel, wherein the RF waveform transmitted over the wireless channel satisfies a spectral mask.
